(19) United States
(12) Patent Application Publication
(10) Pub. No.: US 2026/0364970 A1
(43) Pub. Date: Nov. 19, 2026

(54) Method Of Producing Transfer Medium

(71) Applicant: SEIKO EPSON CORPORATION, Tokyo (JP)

(72) Inventors: Haruka SATO, Shiojiri (JP); Takayoshi KAGATA, Shiojiri (JP)

(21) Appl. No.: 19/561,968

(22) Filed: Mar. 10, 2026

(30) Foreign Application Priority Data
Mar. 11, 2025 (JP) 2025-038088

(51) Int. Cl. B41M 5/52; B41M 5/50

(52) U.S. Cl. CPC B41M 5/5272; B41M 5/506

(57) ABSTRACT

A method of producing a transfer medium includes: a feeding step of feeding a roll-shaped transfer film; a first layer forming step of forming a first layer by attaching an image forming ink containing a coloring material, an organic solvent, and water to a first surface of the fed transfer film by an ink jet method; and a second layer forming step of forming a second layer by attaching an adhesive ink containing a resin, an organic solvent, and water to overlap the first layer by an ink jet method, in which the transfer film has an ink receiving layer on a second surface which is the back side of the first surface, or the second surface is subjected to anti-slip processing.

The present application is based on, and claims priority from JP Application Serial Number 2025-038088, filed Mar. 11, 2025, the disclosure of which is hereby incorporated by reference herein in its entirety.

### BACKGROUND

### 1. Technical Field

The present disclosure relates to a method of producing a transfer medium.

### 2. Related Art

In recent years, as a technique for transferring an image to a textile product or various materials, a printing technique employing a thermal transfer system has been widely used. Among them, direct-to-film printing (DTF) is one method of printing an image on a film by an ink jet method and transferring the image in a post-process. In the DTF method, an image is first formed on a transfer film by using a pigment ink and an adhesive ink, and then the image is transferred to a final product by heating and pressurization, whereby excellent color developability and durability can be realized.

In a heretofore adopted transfer process of the DTF method, a “powder method” is generally used in which resin powder (hot melt powder) is sprinkled on a printed ink layer and heated to form an adhesive layer. However, in this method, when a device for winding the transfer film by a roll to roll method is used, it is necessary to attach, to a printer, a dedicated device for automatically sprinkling the resin powder, and a problem of an increase in apparatus size has arisen.

As a solution to this problem, in recent years, an “adhesive ink method” has been proposed in which an adhesive is discharged by an ink jet method instead of using resin powder. By using the adhesive ink method, a dedicated device for sprinkling powder is not required, and space saving can be achieved. In addition, since the adhesive can be applied only to a necessary region, wasteful use of a material can be reduced, and processes of sprinkling powder and removing excess powder are not required.

However, when the adhesive ink method is adopted, a new problem arises. Specifically, since the resin solid content in the ink is relatively small, there is a problem in that it is necessary to secure a large amount of the adhesive ink ejected onto the film. In the case of a heretofore used film having an ink receiving layer only on one surface, the back surface thereof is often made of a material such as a PET film, and when the ejection amount of the adhesive increases, blocking (sticking between wound and stacked sheets) is likely to occur at the time of winding.

For example, JP-A-2024-17827 discloses an ink ejection section that ejects ink to a release sheet, an adhesive liquid application section that applies an adhesive liquid onto the release sheet, and a device for feeding and winding the release sheet. In this technique, the adhesive liquid is applied by a wet-on-wet method without performing heating and drying after ink ejection. However, in this technique, sufficient consideration is not given to suppression of blocking that occurs when the transfer film is wound up.

In the related art, in the transfer film winding process, film surfaces may stick to each other (blocking may occur) due to the adhesiveness of undried ink or the adhesive ink. In particular, the risk of blocking increases when the total attachment amount of an image forming ink and the adhesive ink is 120 g/m² or more, and due to influence of components (for example, glycerin) contained in the adhesive ink.

### SUMMARY

A method of producing a transfer medium according to the present disclosure includes: a feeding step of feeding a roll-shaped transfer film; a first layer forming step of forming a first layer by attaching an image forming ink containing a coloring material, an organic solvent, and water to a first surface of the fed transfer film by an ink jet method; and a second layer forming step of forming a second layer by attaching an adhesive ink containing a resin, an organic solvent, and water to overlap the first layer by an ink jet method, in which the transfer film has an ink receiving layer on a second surface which is the back side of the first surface, or the second surface is subjected to anti-slip processing.

### BRIEF DESCRIPTION OF THE DRAWINGS

FIG. 1 is a cross-sectional view illustrating a layer structure of a transfer film (single side PET film) having an ink receiving layer on one side according to the present disclosure.

FIG. 2 is a cross-sectional view illustrating a layer structure of a transfer film (double side PET film) having ink receiving layers on both sides according to the present disclosure.

FIG. 3 is a table showing compositions of inks.

FIG. 4 is a table showing results of Examples and Comparative Examples.

### DESCRIPTION OF EMBODIMENTS

An embodiment of the present disclosure (hereinafter, referred to as “the present embodiment”) will be described in detail below with reference to the drawings as necessary, but the present disclosure is not limited thereto, and various modifications can be made without departing from the gist of the present disclosure. In the drawings, the same elements are denoted by the same reference numerals, and the repetitive description will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Method of Producing Transfer Medium

A method of producing a transfer medium according to the present embodiment includes: a feeding step of feeding a roll-shaped transfer film; a first layer forming step of forming a first layer by attaching an image forming ink containing a coloring material, an organic solvent, and water to a first surface of the fed transfer film by an ink jet method; and a second layer forming step of forming a second layer by attaching an adhesive ink containing a resin, an organic solvent, and water to overlap the first layer by an ink jet method, in which the transfer film has an ink receiving layer on a second surface which is the back side of the first surface, or the second surface is subjected to anti-slip processing.

The heretofore used powder method hardly causes blocking since a resin powder layer is formed. However, problems therewith are an increase in apparatus size and an increase in maintenance load. On the other hand, in the method using the adhesive ink in an ink jet method, although downsizing of the apparatus and improvement of application efficiency of the adhesive can be achieved, the problem of blocking is liable to occur due to an increase in the ejection amount of the ink.

In particular, when a film having an ink receiving layer only on one surface is used, since the back surface is made of a non-absorbent material such as a PET film, excess ink or adhesive remains on the front surface, which causes a problem of sticking to an adjacent layer at the time of winding. In order to solve this problem, techniques such as heating and drying have been proposed in the related art, but in order to obtain a sufficient effect, it has been necessary to increase the complexity of the apparatus and extend treatment time.

On the other hand, in the present disclosure, an ink receiving layer is also formed on a second surface of the transfer film, or the second surface is subjected to anti-slip processing, thereby suppressing occurrence of blocking. Consequently, since an undried adhesive ink is partially absorbed into the receiving layer, a liquid component having high tackiness is suppressed from remaining on the film surface, and there is an effect of preventing occurrence of blocking. In addition, by performing anti-slip processing (matte treatment), the contact area between film surfaces is reduced and the adhesion force between the film surfaces is weakened, and therefore, the sheets can be prevented from strongly adhering to each other during winding or storage.

Therefore, at the time of winding the transfer film, sticking between film surfaces due to the adhesive strength of the adhesive ink is reduced, workability in the production process is improved, and quality maintenance during storage and transportation is facilitated. In addition, by performing the anti-slip processing, the contact area between film surfaces is reduced, and an effect of further suppressing occurrence of blocking is obtained.

Before describing each step in detail, the transfer film will be described in detail below. In the present embodiment, the transfer film is a medium for printing an image and transferring the image to a final product, and is a film that plays a major role in a direct-to-film printing (DTF) system.

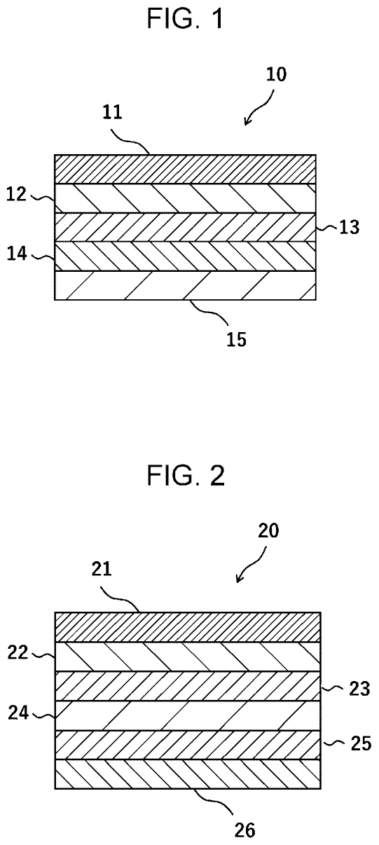

FIG. 1 illustrates a transfer film 10 (single side PET film) having an ink receiving layer on one side, and FIG. 2 illustrates a transfer film 20 (double side PET film) having ink receiving layers on both sides.

As illustrated in FIG. 1, the transfer film 10 of a single-sided ink receiving type having a layer structure enabling ink jet printing may have a structure in which an antistatic coating 14, a matte coating 13, an aqueous release coating 12, and an ink receiving layer 11 are sequentially stacked on a base film 15 used as a base material such as PET.

In addition, as illustrated in FIG. 2, the double-sided processed type transfer film having an ink receiving function on both sides may have a surface on which a matte coating 23, an aqueous release coating 22, and an ink receiving layer 21 are stacked, and a surface on which a matte coating 25 and an antistatic coating 26 are stacked, with a base film 24 as a center. An ink receiving layer (not shown) may be further provided on the antistatic coating 26.

The base films 15 and 24 are base material films such as polyethylene terephthalate (PET), and can secure rigidity, durability, and heat resistance of the entire film. The antistatic coatings 14 and 26 can prevent charging of the film and improve stability during printing and transport. In particular, when a powder treatment is performed, an effect of preventing uneven adhesion of powder due to static electricity may be exhibited.

Further, the matte coatings 13, 23, and 25 may suppress gloss of the film surface and improve workability at the time of transfer, and by applying the matte coatings, slipping due to a transport roller is suppressed and highly accurate transportation is enabled, and in addition, the contact area between film surfaces is reduced, and it is possible to prevent adhesion of adjacent film surfaces even when the highly sticky adhesive ink is in an undried state. The anti-slip processing may include providing the matte coatings 13 and 23 in addition to adjusting the state of the outermost surface.

Further, the aqueous release coatings 12 and 22 are each a layer for allowing the film to be easily peeled off after transfer while improving the adhesion of the ink after ink jet printing. In addition, the ink receiving layers 11 and 21 are each a layer to which an image forming ink is fixed, and enable high-definition image formation. By performing an appropriate drying step after printing, color developability and transfer resistance of ink are improved. Consequently, it is possible to prevent adhesion of adjacent film surfaces even when the highly sticky adhesive ink is in an undried state.

In the present disclosure, by using the transfer film in which the ink receiving layer is formed or the anti-slip processing is performed on both sides as described above, it is possible to effectively suppress occurrence of blocking which occurs when the transfer film is wound up. In particular, by providing the matte coatings 13 and 23 or the ink receiving layers 15 and 25 provided on the back surface as illustrated in FIG. 2, the contact area between the film surfaces is reduced, and it is possible to prevent adhesion of adjacent film surfaces even when the highly sticky adhesive ink is in an undried state. Consequently, the double-sided processed transfer film can easily maintain a stable form even during transportation or storage of the film, and can reduce variation in quality in the winding step. Furthermore, provision of the ink receiving layer on both sides improves ink absorptivity, prevents blocking, and also contributes to improvement in printing quality and transfer performance.

In a recording method using the transfer film, first, an image is formed on an ink receiving layer using a recording apparatus such as an ink jet printer, and then adhesive powder is applied onto the image, followed by heat treatment, whereby the transfer film is processed to have a state suitable for a transfer step. Thereafter, the transfer film is disposed on a transfer object such as a cloth or a synthetic resin to be a transfer target, and heat and pressure are applied to transfer the image. Finally, after cooling, the transfer film is peeled off and the image is fixed to the transfer object.

### 1. 1. Feeding Process

The feeding step is not particularly limited as long as it is a step of feeding the roll-shaped transfer film, but it is preferable to spread the transfer film while maintaining appropriate tension so that the transfer film can be subjected to a process such as printing. The feeding step may be performed by a transport mechanism of the recording apparatus or the transfer film supply apparatus.

### 1. 2. First Layer Forming Step

A first layer forming step is a step of forming a first layer by attaching an image forming ink containing a coloring material, an organic solvent, and water to a first surface of the transfer film fed as described above by an ink jet method.

Here, the “first surface” refers to a main surface of the transfer film to which the image forming ink is attached, and is usually a surface of the ink receiving layer 11 or 21 in order to improve ink fixability. Attachment of ink to the first layer refers to a layer on the first surface (ink receiving layer) to which the image forming ink is attached by an ink jet method, and this layer becomes the basis of the image to be finally transferred to the transfer object.

On the other hand, the transfer film also has a “second surface” as a back surface of the first surface, and this surface is not provided with the ink receiving layer in the single-sided type transfer film as illustrated in FIG. 1, but may be subjected to the anti-slip processing as described later. Further, in the double-sided type transfer film, the second surface also has the ink receiving layer, and in addition thereto, the anti-slip processing may be performed.

In this step, the first layer is formed by attaching the image forming ink containing a coloring material, an organic solvent, and water to the first surface of the transfer film by an ink jet method. The image forming ink is not particularly limited as long as it can be ejected by an ink jet method to form an image, and may contain a coloring material including a pigment or a dye, an organic solvent, water, and an additional dispersant and stabilizer. In particular, a pigment ink is widely used in the DTF method because of excellent in durability, color developability, and water resistance.

The ink jet method refers to a printing method in which a liquid ink is ejected from a fine nozzle and is directly attached to the first surface of the transfer film. This method can form a high-definition image, and can attach the ink only to a necessary portion.

The ink receiving layer is a layer provided on a surface of the transfer film for appropriately holding an ink and improving image forming performance. This layer not only suppresses the diffusion of the ink and maintains a high-definition image, but also serves to enhance the fixability of the ink and shorten drying time. In addition, since color developability and durability of the ink are improved at the time of transfer, the layer also contributes to improvement of quality of the transfer medium. In the present disclosure, by providing the ink receiving layer also on the second surface, an effect of absorbing the sticking strength of excess ink or adhesive ink at the time of winding and suppressing blocking can be obtained.

The ink receiving layer is not particularly limited, and examples thereof include a layer of a resin obtained by copolymerizing an acrylic monomer such as methyl methacrylate, butyl acrylate, or 2-ethylhexyl acrylate, or an aromatic monomer such as styrene, and an inorganic layer such as silica.

The anti-slip processing refers to a treatment for preventing film surfaces from smoothly adhering to each other by an uneven structure or matte processing applied to the second surface of the transfer film. This processing not only prevents blocking at the time of winding, but also reduces the contact area between film surfaces, whereby reducing sticking strength. In addition, an influence of stickiness due to a change in temperature or humidity is suppressed, which contributes to improvement in storage stability and transportability of the transfer medium.

In the first layer forming step, it is preferable that a colored ink and a white ink be attached as the image forming ink. Consequently, color developability and masking properties tend to be further improved. Here, the white ink may be an ink intended to form a base from the viewpoint of masking properties or the like, and the colored ink may be an ink intended to be stacked on the white ink.

The components constituting the image forming ink may include a pigment, a resin, a solvent, a surfactant, and the like.

The pigment is not particularly limited, and examples thereof include carbon black (C.I. Pigment Black 7) such as furnace black, lamp black, acetylene black, and channel black; inorganic pigments such as iron oxide and titanium oxide; and organic pigments such as quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments. The pigment may be used alone or in combination of two or more kinds thereof.

The content of the pigment is preferably 0.5% by mass to 15% by mass, 1% by mass to 12.5% by mass, or 3% by mass to 10% by mass.

Examples of the resin include, but are not particularly limited to, resins such as a urethane-based resin, an acrylic resin (including a styrene-acrylic resin), a fluorene-based resin, a polyolefin-based resin, a rosin-modified resin, a terpene-based resin, a polyester-based resin, a polyamide-based resin, an epoxy-based resin, and a vinyl chloride-based resin.

The urethane-based resin is not particularly limited, and examples thereof include a urethane resin emulsion. The urethane resin emulsion is not particularly limited so long as it is a resin emulsion having a urethane bond in the molecule, and examples thereof include a polyether-type urethane resin containing an ether bond in the main chain, a polyester-type urethane resin containing an ester bond in the main chain, and a polycarbonate-type urethane resin containing a carbonate bond in the main chain. Among these, cationic or anionic urethane resin fine particles are preferred.

The acrylic resin is not particularly limited, and examples thereof include a resin obtained by polymerizing a (meth)acrylic monomer such as (meth)acrylic acid or a (meth)acrylic acid ester, and an acrylic resin emulsion obtained by copolymerizing a (meth)acrylic monomer and another monomer.

The content (solid content) of the resin is preferably 2.0% by mass to 15% by mass, 3.0% by mass to 10% by mass, or 4.0% by mass to 8.0% by mass with respect to the total mass of the image forming ink. Consequently, dispersion stability of the pigment in the image forming ink can be made more excellent while making ejection stability of the image forming ink by an ink jet method, transfer product production stability, and texture of the transfer product sufficiently excellent.

The organic solvent is not particularly limited, and examples thereof include a polyol compound, a glycol ether, and a cyclic amide compound. The organic solvent may be used alone or in combination of two or more kinds thereof.

Examples of the polyol compound include, but are not limited to, glycols such as 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol.

Examples of the glycol ether include monoalkyl ethers of a glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ether include triethylene glycol monomethyl ether, triethylene glycol monobutyl ether, triethylene glycol monoethyl ether, and dipropylene glycol monopropyl ether.

The content of the organic solvent is preferably 5% by mass to 35% by mass, 10% by mass to 30% by mass, or 15% by mass to 25% by mass with respect to the total mass of the image forming ink.

The surfactant is not particularly limited, and examples thereof include an acetylene glycol-based surfactant, a silicone-based surfactant, and a fluorine-based surfactant. Note that one kind of the surfactant may be used alone, or two or more kinds thereof may be used in combination.

The acetylene glycol-based surfactant is not particularly limited, and examples thereof include: alkylene oxide adducts of 2,4,7,9-tetramethyl-5-decyne-4,7-diol and 2,4,7,9-tetramethyl-5-decyne-4,7-diol; and alkylene oxide adducts of 2,4-dimethyl-5-decyne-4-ol and 2,4-dimethyl-5-decyne-4-ol.

The silicone-based surfactant is not particularly limited, and examples thereof include a polysiloxane-based compound and a polyether-modified organosiloxane.

The fluorine-based surfactant is not particularly limited, and examples thereof include a perfluoroalkyl sulfonic acid salt, a perfluoroalkyl carboxylic acid salt, a perfluoroalkyl phosphoric acid ester, a perfluoroalkyl ethylene oxide adduct, a perfluoroalkyl betaine, and a perfluoroalkylamine oxide compound.

The content of the surfactant is preferably 0.02% by mass to 1.50% by mass, 0.05% by mass to 1.00% by mass, or 0.10% by mass to 0.70% by mass with respect to the total mass of the image forming ink.

The content of water is preferably 50% by mass to 80% by mass, 55% by mass to 75% by mass, or 60% by mass to 70% by mass with respect to the total amount of the image forming ink. Consequently, the viscosity and surface tension of the image forming ink can be more suitably adjusted.

The image forming ink may contain various additives such as a dissolution aid, a viscosity modifier, a pH modifier, an antioxidant, a preservative, a fungicide, a corrosion inhibitor, and a chelating agent for capturing a metal ion that affects dispersion.

An attachment amount of the colored ink in the image forming ink is preferably 10 to 30 g/m², 12.5 to 27.5 g/m², or 15 to 25 g/m². When the attachment amount of the colored ink falls within the above ranges, transferability and blocking resistance tend to be further improved.

The attachment amount of the white ink in the image forming ink is preferably 10 to 30 g/m², 12.5 to 27.5 g/m², or 15 to 25 g/m². When the attachment amount of the white ink falls within the above ranges, transferability and blocking resistance tend to be further improved.

The total attachment amount of the image forming ink is preferably 20 to 60 g/m², 25 to 55 g/m², or 30 to 50 g/m². When the attachment amount of the image forming ink falls within the above ranges, transferability and blocking resistance tend to be further improved.

### 1. 3. Second Layer Forming Step

In a second layer forming step, a second layer is formed by attaching an adhesive ink containing a resin, an organic solvent, and water by an ink jet method so as to overlap the first layer. Here, “so as to overlap” means that the adhesive ink is attached at the same position as the position where the image forming ink on the first layer is attached or in the vicinity thereof. Consequently, the adhesive effectively functions at the time of transfer, and the image is appropriately transferred to the transfer object.

The adhesive ink is not particularly limited as long as it is an ink having a sticking function for fixing an image to a transfer object after transfer, and may contain, for example, a resin component that mainly exhibits an adhesive function. Specifically, the adhesive ink may contain a resin such as polyester or polyurethane for increasing the adhesive force, an organic solvent, and water for adjusting the viscosity or dispersibility of the ink. By ensuring an appropriate application amount of the adhesive ink, durability and adhesion of the image after transfer can be improved.

The second layer refers to a layer of the adhesive ink formed so as to overlap the first layer, and this layer is bonded to the transfer object at the time of transfer and serves to fix the image. Uniform application of the adhesive ink may improve transfer quality, rub resistance, and washing fastness.

Components constituting the adhesive ink may include a resin, a solvent, a surfactant, and the like.

The resin is not particularly limited, and examples thereof include the resins exemplified in the image forming ink. Among these, polyester is preferable. Consequently, transferability, blocking resistance, and the like tend to be further improved. The organic solvent may be used alone or in combination of two or more kinds thereof.

The content (solid content) of the resin is preferably 5.0% by mass to 25% by mass, 7.5% by mass to 20% by mass, or 10% by mass to 22.5% by mass with respect to the total mass of the adhesive ink composition.

The organic solvent is not particularly limited, and examples thereof include the same organic solvents as those exemplified for the ink composition. Among these, glycerin is preferable. Consequently, transferability, blocking resistance, and the like tend to be further improved. The organic solvent may be used alone or in combination of two or more kinds thereof.

The content of the organic solvent is preferably 7.5% by mass to 35% by mass, 10% by mass to 30% by mass, or 12.5% by mass to 25% by mass with respect to the total mass of the adhesive ink.

The surfactant is not particularly limited, and examples thereof include the same surfactants as those exemplified for the ink composition. The organic solvent may be used alone or in combination of two or more kinds thereof. One kind of the surfactant may be used alone, or two or more kinds thereof may be used in combination.

The content of the surfactant is preferably 0.02% by mass to 1.50% by mass, 0.05% by mass to 1.00% by mass, or 0.10% by mass to 0.70% by mass with respect to the total mass of the adhesive ink.

The content of water is preferably 50% by mass to 80% by mass, 55% by mass to 75% by mass, or 60% by mass to 70% by mass with respect to the total amount of the adhesive ink. Consequently, the viscosity and surface tension of the image forming ink can be more suitably adjusted.

The adhesive ink may contain various additives such as a dissolution aid, a viscosity modifier, a pH modifier, an antioxidant, a preservative, a fungicide, a corrosion inhibitor, and a chelating agent for capturing a metal ion that affects dispersion.

The attachment amount of the adhesive ink is preferably 40 to 250 g/m², 60 to 225 g/m², 80 to 200 g/m², or 100 to 175 g/m². When the attachment amount of the adhesive ink falls within the above ranges, transferability and blocking resistance tend to be further improved.

The total attachment amount of the image forming ink and the adhesive ink is preferably 80 g/m² or more, 100 g/m² or more, 120 g/m² or more, 140 g/m² or more, or 160 g/m² or more. In addition, the total attachment amount of the image forming ink and the adhesive ink is preferably 300 g/m² or less, 275 g/m² or less, 250 g/m² or less, or 225 g/m² or less. When the total attachment amount of the image forming ink and the adhesive ink falls within the above ranges, transferability and blocking resistance tend to be further improved.

The ratio of the attachment amount of the adhesive ink to the attachment amount of the image forming ink is preferably 100% to 1500%, 200% to 1300%, 300% to 1100%, or 400% to 1000%. When the attachment amount ratio falls within the above ranges, transferability and blocking resistance tend to be further improved.

### 1. 4. Drying Step

The drying step is a step of heating and drying the transfer film on which the second layer is formed. The drying temperature is preferably 80 °C to 200 °C, 100 °C to 190 °C, 120 °C to 180 °C, or 140 °C to 170 °C. In addition, the drying time is preferably 1 to 10 minutes, 2 to 9 minutes, 3to 8 minutes, or 4 to 7 minutes. Consequently, transferability and blocking resistance tend to be further improved.

### 1. 5. Winding Step

A winding step is a step of winding the transfer film on which the second layer is formed into a roll shape. Specifically, by winding the transfer film after drying with a winding device in which tension is controlled, it is possible to suppress occurrence of deformation and wrinkling of a sheet while maintaining a uniform winding form.

In addition, when such a roll is used, there is a concern that blocking may occur since the front and back surfaces of the transfer film come into contact with each other. However, in the present embodiment, it is possible to suppress sticking between film surfaces by providing the ink receiving layer on the second surface of the transfer film or subjecting the second surface of the transfer film to anti-slip processing (matte processing). Further, by performing a cooling treatment immediately after winding, the temperature of the film surface may be rapidly lowered to reduce stickiness. By appropriately controlling these processes, the quality of the transfer medium can be maintained, and troubles during storage and transport can be reduced.

### 1. 6. Transfer Step

The transfer step is a step of transferring the image formed on the dried transfer film to a transfer object, and is mainly performed using heat and pressure. In this step, the image formed on the ink receiving layer and the adhesive ink layer are required to be firmly fixed to a surface of the transfer object.

Specifically, after the transfer film is brought into close contact with the surface of the transfer object, the adhesive ink layer is softened or melted by applying a certain temperature and pressure, and the ink layer is transferred to the surface of the transfer object. Thereafter, the transfer film is peeled off through a cooling step, whereby the final image is fixed to the transfer object.

Examples of the transfer method include a thermal transfer method (heat press method) and a roller pressure bonding method. Stable transfer quality can be secured by uniformly applying a certain temperature and pressure in the thermal transfer method. On the other hand, the roller pressure bonding method is suitable for performing transfer while continuously applying pressure.

The transfer temperature is preferably 140 °C to 200 °C, 150 °C to 190 °C, or 160 °C to 180 °C. In addition, the transfer time is preferably 10 to 70 seconds, 20 to 60 seconds, or 30 to 50 seconds.

The transfer object is not particularly limited, and examples thereof include fabric such as cotton and silk; and resin materials such as polyolefin and polyester.

### EXAMPLES

The present disclosure will be described in more detail with reference to Examples and Comparative Examples. The present disclosure is not limited by following Examples.

1. 1. Image forming ink and adhesive ink

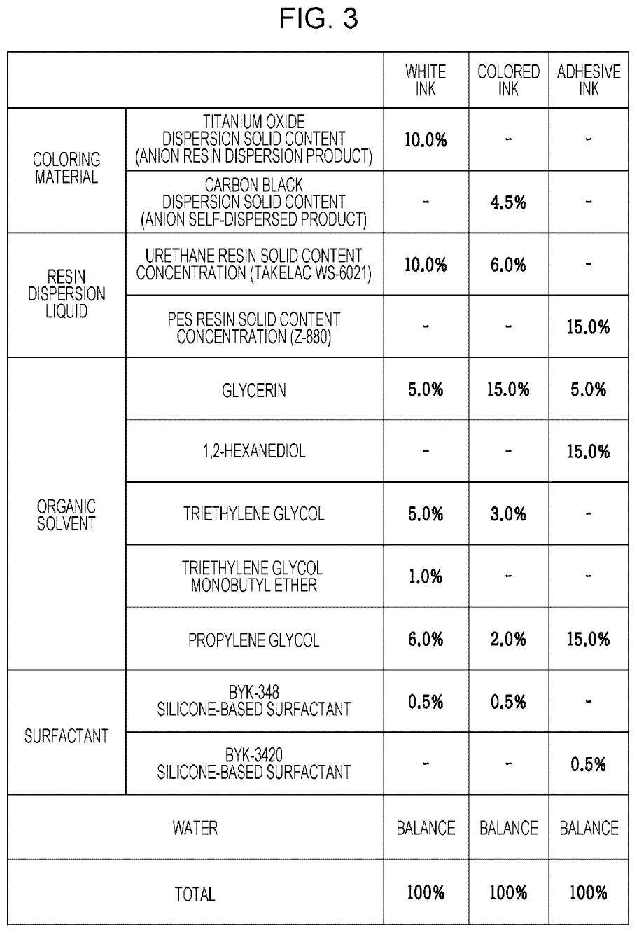

FIG. 3 is a table showing the compositions of image forming inks and an adhesive ink. Components were put in a mixture tank so as to achieve each composition shown in FIG. 3, mixed and stirred, and further filtered through a membrane filter to obtain each of the image forming inks and adhesive ink of each example. Unless otherwise specified, numerical values for the respective components shown in each example in the table indicate mass %. In the table, the numerical value of each pigment represents mass % of the solid content.

The abbreviations and details of the product components used in FIG. 3 are as follows.

### Coloring Material

Titanium oxide dispersion (anion resin dispersion product)
Carbon black dispersion (anion self-dispersed product)

### Resin Dispersion Liquid

Urethane resin (TAKELAC WS-6021)
Polyethersulfone resin (PES resin) (Z-880)

### Solvent

Glycerin
Triethylene glycol
Triethylene glycol monobutyl ether
Propylene glycol

### Surfactant

Silicone-based surfactant (BYK-348)
Silicone-based surfactant (BYK-3420)
   1. 2. Transfer film

Transfer film 1: manufactured by PRINTWANT Corporation, product name “double side hot peel DTF PET film”

Transfer film 2: manufactured by ECOFREEN CO., LTD., product name “Eco Freen Premium”

### 2. Evaluation Method

In order to confirm effects of the present disclosure, Examples and Comparative Examples were evaluated with respect to the following evaluation items. An evaluation method and evaluation criteria are described for each item.

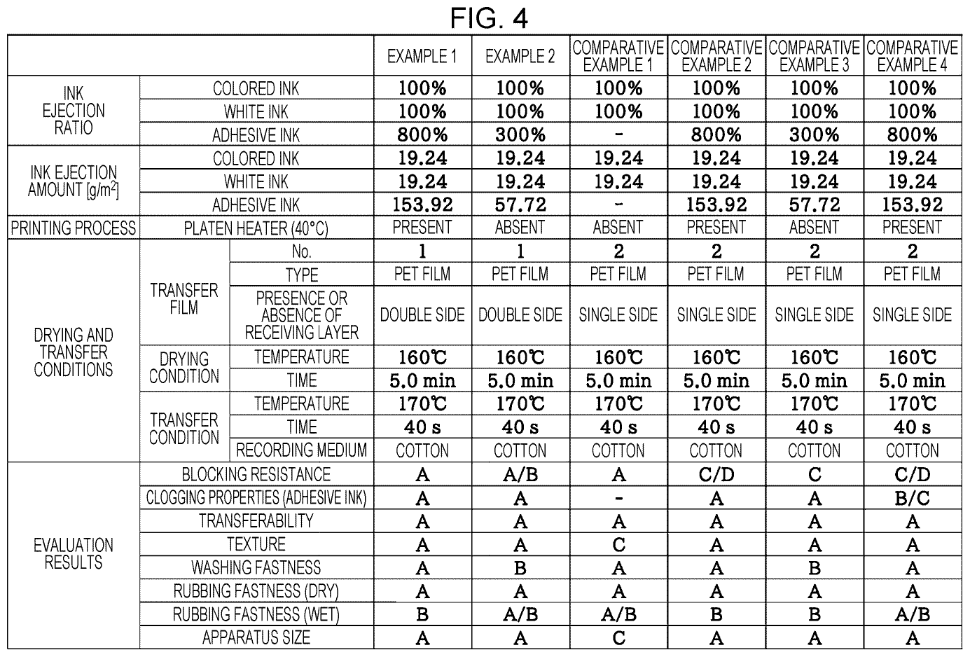

The transfer film shown in FIG. 4 was prepared, and the image forming ink was ejected onto the ink receiving layer (first layer) of the transfer film under the conditions shown in FIG. 4 using an ink jet printer (PX-G930, manufactured by Seiko Epson Corporation). Then, the adhesive ink was applied onto the first layer by an ink jet method to form an adhesive layer. Attachment conditions of the adhesive ink were adjusted according to the conditions shown in FIG. 4.

The transfer film to which the adhesive ink was attached was dried using a hot air dryer, and then the dried transfer film was transferred to a transfer object (fabric made of 100% cotton) according to the conditions described in FIG. 4. After the transfer, the transfer film was cooled, and the transfer film was peeled off to obtain recorded matter.

### 2. 1. Texture

The texture of the recorded matter according to each of Examples and Comparative Examples was evaluated. Sensory evaluation was performed by a specific evaluator, and ranked according to the following criteria. Evaluation results A, B, and C indicate the order of excellence of texture in descending order. When the evaluation result is A or B, it can be determined that the effect of the present disclosure is obtained.

### Evaluation Criteria

A: The recorded matter is soft and exhibits coarse texture.
B: The recorded matter is slightly hard and exhibits Slightly Coarse Texture.
C: The recorded matter exhibits significantly coarse texture.

### 2. 2. Dry Rubbing Fastness

Abrasion resistance of the recorded matter according to each of Examples and Comparative Examples was evaluated. As a test method, a Gakushin-type rubbing fastness tester (AB-301, manufactured by TESTER SANGYO CO., LTD.) was used, and after rubbing 20 times with a cotton cloth under a load of 200 g, the peeling state of the recording surface and ink transfer to the cotton cloth were visually evaluated. The evaluation results were ranked in the order of A, B, and C, and rating of B or higher was regarded as a good level.

### Evaluation Criteria

A: Neither color transfer nor peeling is observed.
B: Color transfer and peeling are slightly observed.
C: Color transfer and peeling are clearly observed.

### 2. 3. Wet Rubbing Fastness

Abrasion resistance in a wet environment of the recorded matter according to each of Examples and Comparative Examples was evaluated. As a test method, a Gakushin-type rubbing fastness tester (AB-301, manufactured by TESTER SANGYO CO., LTD.) was used, and after rubbing 20 times with a cotton cloth immersed in pure water under a load of 200 g, the peeling state of the recording surface and ink transfer to the cotton cloth were visually evaluated. The evaluation results were ranked in the order of A, B, and C, and rating of B or higher was regarded as a good level.

### Evaluation Criteria

A: Neither color transfer nor peeling is observed.
B: Color transfer and peeling are slightly observed.
C: Color transfer and peeling are clearly observed.

### 2. 4. Washing Fastness

Washing fastness of the recorded matter according to each of Examples and Comparative Examples was evaluated. A washing fastness test (ISO 105 C10(B2 )) was performed and evaluated according to the following criteria. The evaluation results were ranked in the order of A, B, and C, and rating of B or higher was regarded as a good level.

### Evaluation Criteria

A: Washing fastness is Grade 3 or higher.
B: Washing fastness is Grade 2 or higher and lower than Grade 3.
C: Washing fastness is Grade 2 or lower.

### 2. 5. Transferability

When each printed material was transferred to a printing medium, the state of peeling from the film was visually confirmed and evaluated according to the following criteria.

### Evaluation Criteria

A: 100% of the printed image area has been transferred.
B: 80% or more and less than 100% of the printed image area has been transferred.
C: Less than 80% of the printed image area has been transferred.

### 2. 6. Clogging Properties

An ink jet printer (PX-G930, manufactured by Seiko Epson Corporation) was used, loaded with the ink composition, and left for one month in a state where the cap was opened. Thereafter, cleaning was performed three times, and the presence or absence of non-ejecting nozzles was confirmed. Evaluation criteria are as follows.

### Evaluation Criteria

A: There are no non-ejecting nozzles.
B: There are 1 to 5 non-ejecting nozzles.
B-: There are 6 to 20 non-ejecting nozzles.
C: There are 21 or more non-ejecting nozzles.

### 2. 7. Apparatus Size

Based on the size of installation areas of the printer and an automatic device that sprinkles powder, a comparison was made with installation areas of the printer and a printing device that ejects a treatment liquid. In addition, when an operation of manually sprinkling powder without using an automatic device is performed, a work space for sprinkling powder is also included in the installation area. Evaluation criteria are as follows.

### Evaluation Criteria

A: The installation area of the apparatus size is less than 50%.
B: The installation area of the apparatus size is 50% or more and less than 100%.
C: The installation area of the apparatus size is 100% or more.

### 2. 8. Blocking Resistance

A sample of A5 size having a solid image formed on the entire surface thereof was allowed to stand in an environment of 25 °C and 50% RH for 72 hours, and then two sheets of the sample were superimposed on each other and subjected to a load of 1 kg/cm², and allowed to stand in an environment of 80 °C and 30% RH for 16 hours. Thereafter, the sample was returned to an environment of 25 °C and 50% RH and allowed to stand for 24 hours, and then the sample was peeled off, and the state of the image surface was visually observed and evaluated according to the following criteria. The evaluation criteria of A to B are within a range having no practical problem.

### Evaluation Criteria

A: No damage is observed on the image surface.
B: Gloss of the surface changes.
C: A part of the image is destroyed in a spot shape.
D: At least 10% of the image is destroyed.

What is claimed is:

1. A method of producing a transfer medium, comprising:
a feeding step of feeding a roll-shaped transfer film;
a first layer forming step of forming a first layer by attaching an image forming ink containing a coloring material, an organic solvent, and water to a first surface of the fed transfer film by an ink jet method; and
a second layer forming step of forming a second layer by attaching an adhesive ink containing a resin, an organic solvent, and water to overlap the first layer by an ink jet method, wherein
the transfer film has an ink receiving layer on a second surface which is a back side of the first surface, or the second surface is subjected to anti-slip processing.

2. The method of producing a transfer medium according to claim 1, wherein
a total attachment amount of the image forming ink and the adhesive ink is 120 g/m² or more.

3. The method of producing a transfer medium according to claim 1, wherein
a colored ink and a white ink are attached as the image forming ink in the first layer forming step.

4. The method of producing a transfer medium according to claim 1, wherein
a content of the resin contained in the adhesive ink is 5.0% by mass to 25% by mass with respect to a total amount of the adhesive ink.

5. The method of producing a transfer medium according to claim 1, wherein
the resin contained in the adhesive ink includes polyester.

6. The method of producing a transfer medium according to claim 1, wherein
the organic solvent contained in the adhesive ink includes glycerin.

7. The method of producing a transfer medium according to claim 1, further comprising:
a drying step of heating and drying the transfer film on which the second layer is formed.

8. The method of producing a transfer medium according to claim 1, further comprising:
a winding step of winding the transfer film on which the second layer is formed into a roll shape.
